(19) United States
(12) Patent Application Publication
(10) Pub. No.: US 2020/0237589 A1
(43) Pub. Date: Jul. 30, 2020

(54) ELECTRIC WHEELCHAIR

(71) Applicant: LG ELECTRONICS INC., Seoul (KR)

(72) Inventors: Haemin CHOI, Seoul (KR); Wondong DO, Seoul (KR); Jaebeom IM, Seoul (KR); Eulpyo HONG, Seoul (KR)

(21) Appl. No.: 16/594,486

(22) Filed: Oct. 7, 2019

(30) Foreign Application Priority Data
Jan. 29, 2019 (KR) 10-2019-0011279

(51) Int. Cl. A61G 5/12; A61G 5/04

(52) U.S. Cl. CPC A61G 5/125; A61G 2203/70; A61G 2203/14; A61G 5/048

(57) ABSTRACT

An electric wheelchair according to an embodiment of the present disclosure includes a seat configured to allow a person to be seated, a frame configured to support the seat, a driver configured to be coupled to the frame; and an armrest configured to be hinged to the frame, in which the armrest includes a first portion which extends in a vertical direction and is disposed to overlap a side surface of the frame, a second portion which extends forwardly from an upper-end portion of the first portion, and a third portion which extends forwardly from a lower end portion of the first portion, and when the armrest is rotated from the first position to the second position, at least any one of the first portion and the third portion is disposed to overlap the side surface of the frame.

### CROSS-REFERENCE TO RELATED APPLICATIONS

The present application claims priority under 35 U.S.C. 119 and 35 U.S.C. 365 to Korean Patent Application No. 10-2019-0011279 (filed on Jan. 29, 2019), which is hereby incorporated by reference in its entirety.

### BACKGROUND

The present disclosure relates to an electric wheelchair.

In general, a wheelchair refers to a chair with wheels so that a person with a disability, an elderly person, a person who is not free with a leg, or a person who is uncomfortable can move to the desired place while sitting.

Such wheelchairs are classified into manual wheelchairs in which a user manually drives wheels and electric wheelchairs in which wheels are driven by an electric motor according to a driving method thereof.

In general, the manual wheelchair has a structure which is provided with wheels on both sides of a seat portion to allow the user to ride and a ring member is provided to rotate the wheels, and the overall size of the manual wheelchair can be reduced by the simple operation of folding the seat using a separate lever and then the wheelchair can be mounted on a vehicle.

On the other hand, the electric wheelchair is difficult to be separated because the seat portion, the frame, and the driving device are combined in a complex structure, and thus there is a problem that the electric wheelchair cannot be mounted on a vehicle.

In order to solve this problem, Korean Patent As the related art, Korean Patent Publication No. 10-2017-0109286 (Sep. 29, 2017) discloses a detachable and folding electric wheelchair.

The electric wheelchair disclosed in the related document is composed of a frame provided with a wheel and a motor, and a seat unit provided on the upper portion of the frame and provided for a person to sit on. The seat unit further includes a backrest unit for supporting a person's back and an armrest unit for supporting an arm.

Specifically, the backrest unit is formed to extend upward from the edge of the seat unit, and the armrest unit is formed to extend forward from both sides of the backrest unit, respectively. Accordingly, the user can lean comfortably using the backrest unit and the armrest unit while seated in the seat unit.

However, since the armrest unit is maintained as a state of being fixed to both sides of the backrest unit, respectively, it becomes a factor that interferes with the user's boarding. In other words, the user should only board the front of the wheelchair based on the driving direction of the wheelchair, there is a problem that it is difficult to board in the side due to the interference of the armrest unit.

Therefore, an electric wheelchair that is free to ride or get off the wheelchair is required.

### SUMMARY

The present disclosure has been proposed to improve the above problems, and an object of the present disclosure is to provide an electric wheelchair that can solve the interference problem of the armrest unit when getting on or off the wheelchair.

Another object of the present disclosure is to provide an electric wheelchair that can be easily adjusted the position of the armrest unit.

Still another object of the present disclosure is to provide an electric wheelchair that can prevent excessive rotation of the armrest unit by limiting the rotation angle of the armrest unit.

Still another object of the present disclosure is to provide an electric wheelchair that can simplify the assembly of the armrest unit and facilitate the storage of the wheelchair.

An electric wheelchair according to an embodiment of the present disclosure for achieving the above objects provides an armrest unit which is hinged to the frame and is provided to be rotatable from a first position to a second position.

In particular, the armrest unit includes a first portion which extends in a vertical direction and is disposed to overlap a side surface of the frame, a second portion which extends forwardly from an upper-end portion of the first portion, and a third portion which extends forwardly from a lower end portion of the first portion.

At this time, when the armrest unit is rotated from the first position to the second position, at least any one of the first portion and the third portion is disposed to overlap the side surface of the frame, and thus the armrest unit can open the side of a seating unit. In other words, when the side of the seating unit is opened, there is an advantage that the side boarding of the wheelchair becomes easy.

In addition, a triangular armrest is formed by connecting an end portion of the second portion and an end portion of the third portion to each other and thus the supporting force of the armrest unit can be improved. At this time, the angle formed by the first portion and the third portion may be a right angle.

According to the present embodiment, the frame may include an upper frame located above the seat, and a lower frame located below the seat. The angle formed by the side surface of the upper frame and the side surface of the lower frame may be an obtuse angle.

The first portion may be disposed to overlap the side surface of the upper frame at the first position. In addition, the first portion may be disposed to overlap with the side surface of the lower frame at the second position.

In addition, the third portion may be disposed to overlap with the side surface of the upper frame at the second position.

The second portion may be disposed in a direction horizontal to the ground at the first position and is disposed in a direction perpendicular to the ground at the second position.

In addition, the electric wheelchair further includes a hinge assembly configured to connect the armrest unit and the frame, and the hinge assembly may be installed so as to pass through the point where the first portion and the third portion of the armrest unit meet.

At this time, the hinge assembly includes a shaft portion configured to pass through the armrest, and a rotation portion configured to be provided so as to be fitted to the outer circumferential surface of the shaft portion and to be rotatable, and the rotation portion may be fixed to an inner surface of the armrest unit.

In addition, the hinge assembly may further include a rotation limiting portion which configured to be formed so as to surround the outer circumference of the rotation portion, the rotation limiting portion being configured to limit the rotation angle of the rotation portion.

The rotation limiting portion may include an interference portion configured to extend outward from an outer circumferential surface of the shaft to be in contact with a portion of the rotation portion when the rotation portion rotates.

For example, the rotation portion includes a rotation body configured to be inserted into the outer circumferential surface of the shaft so as to rotate; and an engaging portion configured to extend outward from an outer circumferential surface of the rotation body in a radial direction, and the engaging portion may be interfered with the rotation by being in contact with the interference portion when the rotation body rotates.

### BRIEF DESCRIPTION OF THE DRAWINGS

FIG. 1 is a front perspective view illustrating an electric wheelchair according to an embodiment of the present disclosure.

FIG. 2 is a rear perspective view illustrating the electric wheelchair according to the embodiment of the present disclosure.

FIG. 3 is a side view illustrating the electric wheelchair according to an embodiment of the present disclosure.

FIG. 4 is a longitudinal sectional view illustrating the electric wheelchair according to an embodiment of the present disclosure.

FIG. 5 is a view illustrating the inside of the armrest unit according to an embodiment of the present disclosure.

FIG. 6 is an exploded perspective view illustrating the armrest unit according to the embodiment of the present disclosure.

FIG. 7 is a side view illustrating the armrest unit according to an embodiment of the present disclosure.

FIG. 8 is a perspective view illustrating a hinge assembly according to an embodiment of the present disclosure.

FIG. 9 is a plan view illustrating a hinge assembly according to an embodiment of the present disclosure.

FIG. 10 is a side view illustrating a state where the armrest unit is rotated from the first position to the second position according to an embodiment of the present disclosure.

FIG. 11 is a transparent perspective view illustrating the hinge assembly in a state where the armrest unit is rotated to the second position according to an embodiment of the present disclosure.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the disclosure may be practiced. These embodiments are described in sufficient detail to enable those skilled in the art to practice the disclosure, and it is understood that other embodiments may be utilized and that logical structural, mechanical, electrical, and chemical changes may be made without departing from the spirit or scope of the disclosure. To avoid detail not necessary to enable those skilled in the art to practice the disclosure, the description may omit certain information known to those skilled in the art. The following detailed description is, therefore, not to be taken in a limiting sense.

Also, in the description of embodiments, terms such as first, second, A, B, (a), (b) or the like may be used herein when describing components of the present disclosure. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

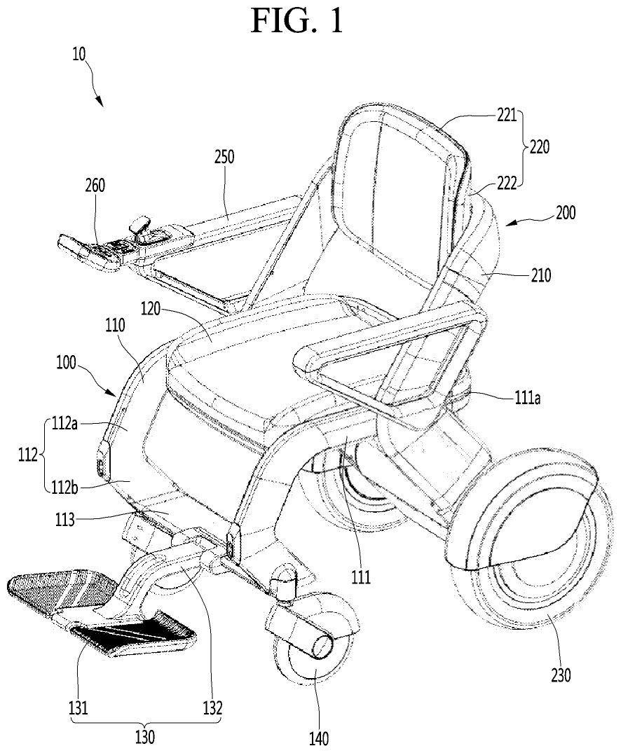

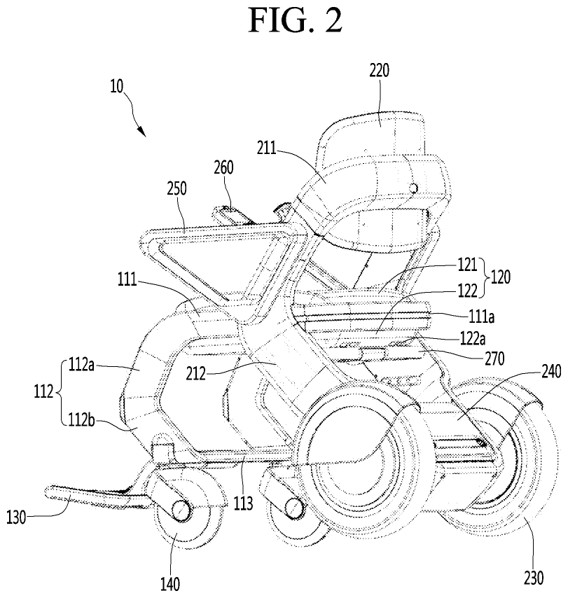

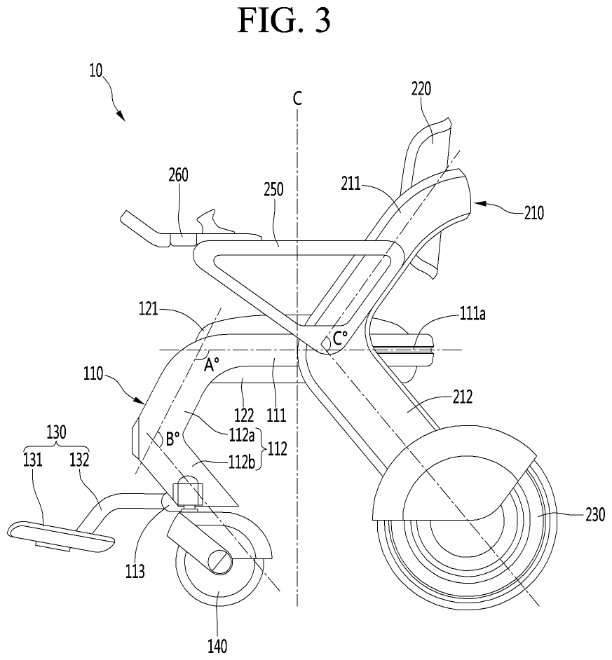

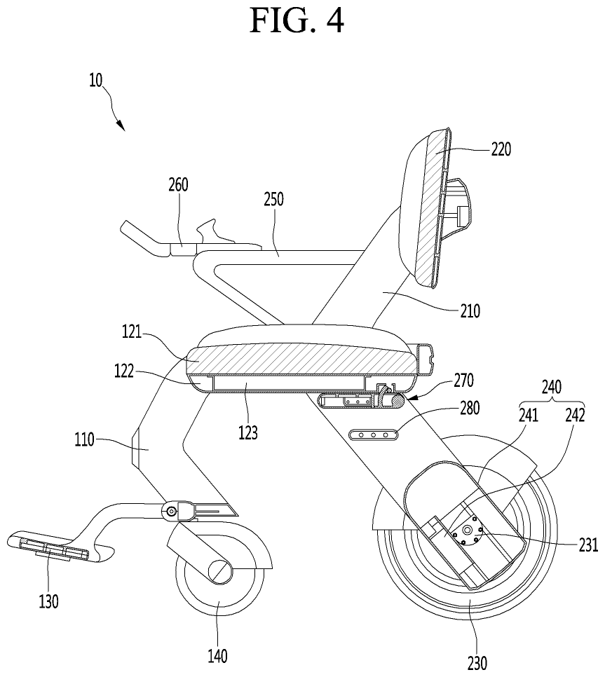

FIG. 1 is a front perspective view illustrating an electric wheelchair according to an embodiment of the present disclosure, FIG. 2 is a rear perspective view illustrating the electric wheelchair according to the embodiment of the present disclosure, FIG. 3 is a side view illustrating the electric wheelchair according to an embodiment of the present disclosure, and FIG. 4 is a longitudinal sectional view illustrating the electric wheelchair according to an embodiment of the present disclosure.

Referring to FIGS. 1 to 4, the electric wheelchair 10 may include a robot.

The electric wheelchair 10 according to the present disclosure includes a first module 100 and a second module 200 coupled to the first module 100.

At least one of the first module 100 and the second module 200 may be referred to as a “robot”.

The first module 100 may be disposed at the front of the electric wheelchair 10, and the second module 200 may be disposed at the rear of the electric wheelchair 10. In addition, the first module 100 and the second module 200 may be detachably coupled to each other.

Here, the “front” means a direction that the electric wheelchair 10 faces while driving, and the “rear” may be understood as the opposite direction of the front.

The first module 100 is defined as a front module because the first module is disposed in front of the electric wheelchair 10, the second module 200 may be defined as a rear module because the second module is disposed in the rear of the electric wheelchair 10.

The first module 100 is a portion provided with a seating unit 120 to allow a person to actually sit. In addition, the first module 100 includes a battery 123. The battery 123 may be provided inside the seating unit 120.

The second module 200 is a portion provided with a plurality of parts for driving of the electric wheelchair 10. The second module 200 includes a main wheel 230 provided with a motor 231 for driving.

In general, an electric wheelchair can be understood as one of the parts with the heaviest battery and motor. Correspondingly, in the present disclosure, when the first module 100 and the second module 200 are separated from each other, the weight of each module can be distributed to the same or similar level by disposing the battery 123 in the first module 100 and disposing the motor 231 in the second module 200. Therefore, there is an advantage that the transfer and loading thereof is easy when the electric wheelchair 10 is separated.

In detail, the first module 100 may include a front frame 110, a seating unit 120 coupled to one side of the front frame 110, and a leg rest unit 130 coupled to the other side.

The front frame 110 is disposed in front of the electric wheelchair 10, and, when the person is seated on the electric wheelchair 10, can support the weight thereof. The front frame 110 may be formed as a closed curve in which the inside is empty.

The seating unit 120 may be disposed above the front frame 110, and the leg rest unit 130 may be disposed below the front frame 110.

According to an embodiment, the front frame 110 may include a first frame 111 supporting the seating unit 120, second frames 112 bent downward from both sides of the first frame 111, respectively, and a third frame 113 connecting each end portion of the second frame 112.

The first frame 111, the second frame 112, and the third frame 113 may be integrally formed.

The first frame 111 may be formed to surround a circumference of the seating unit 120. In other words, the first frame 111 may be formed in a hollow shape so that the seating unit 120 may be inserted into the inside thereof.

At this time, a portion of the inner side surface of the first frame 111 is fixed to both side surfaces of the seating unit 120, so that even if a load is applied to the seating unit 120, the seating unit 120 may be prevented from being deviated from the first frame 111.

For example, the first frame 111 may be formed in a “ [symbol] ” shape. The seating unit 120 may be inserted into and fixed to the inside of the first frame 111. Therefore, the first frame 111 may be seen to cover both side surfaces and the rear surface of the seating unit 120.

In addition, the first frame 111 includes a slide groove 111a.

The slide groove 111a is a portion for being coupled by sliding the first module 100 to the second module 200. The slide groove 111a may be fitted into a slide protrusion (not illustrated) provided in the second module 200 so as to be coupled to the inside of the second module 200.

The slide groove 111a may be recessed inward from an outer surface of the first frame 111. For example, the slide grooves 111a may be formed on both side surfaces of the first frame 111, respectively. The slide groove 111a may be elongated in a front and rear direction on both side surfaces of the first frame 111.

In addition, the slide groove 111a may be formed not only on both side surfaces of the first frame 111 but also on the rear surface of the first frame 111. At this time, the slide grooves 111a may be connected to each other to form one slide groove 111a.

By this configuration, the first module 100 is capable of sliding movement and coupling inside the second module 200 in the front and rear direction.

The second frame 112 is a portion that is bent downward from both sides of the first frame 111, respectively. The second frame 112 may be formed to be rounded downward from the front end portion of the first frame 111.

At this time, the second frame 112 may have a front extension portion 112a extending forward from the first frame 111 and a rear extension portion 112b extending rearward from an end portion of the front extension portion 112a.

In other words, the front extension portion 112a and the rear extension portion 112b may extend in different directions from each other, respectively. Since the front extension portion 112a and the rear extension portion 112b are formed to be rounded in different directions, the entire volume of the front frame 110 may be reduced.

On the other hand, as illustrated in FIG. 3, the angle A formed between the first frame 111 and the first extension portion 112a may be, for example, 120 degrees. In addition, the angle B formed by the first extension portion 112a and the second extension portion 112b may be designed so as to be larger than 90 degrees and smaller than 120 degrees.

In other words, since an angle A formed by the first frame 111 and the first extension portion 112a and an angle formed by the first extension portion 112a and the second extension portion 112b form an obtuse angle, the volume of the front frame 110 can be minimized.

The third frame 113 connects respective end portions of the second frame 112. The third frame 113 is formed long in the horizontal direction and may support the leg rest unit 130 to be described later.

The seating unit 120 is coupled to the inside of the front frame 110 and is configured to allow a person to sit.

The seating unit 120 includes a seat 121 and a seat cover 122 coupled to the lower side of the seat 121.

The sheet 121 may be formed of soft and elastic material as a portion which is in contact with buttocks when a person seats.

The seat cover 122 is coupled to the lower side of the sheet 121 as a portion supporting the sheet 121. The seat cover 122 may be coupled to the inside of the front frame 110. For example, the seat cover 122 may be fastened to the inner surface of the first frame 111 by a fastening member.

In addition, a battery 123 is disposed in the seating unit 120. The battery 123 may provide power to the control box 240 and the motor 231 to be described later.

In detail, the battery 123 may be disposed in the seat cover 122. To this end, the seat cover 122 may form a receiving space to receive the battery 123 therein.

The battery 123 may provide power to a side of the second module 200 when the seat cover 122 is coupled to the second module 200. To this end, a connection groove 122a for inserting a connection terminal (not illustrated) provided in the second module 200 may be formed in the seat cover 122.

The connection groove 122a may be formed on the bottom surface of the seat cover 122. When the connection terminal 274 is inserted into the connection groove 122a, the power of the battery 123 may be transmitted to the motor 231 of the second module 200 through the connection terminal 274.

The leg rest unit 130 supports the leg or the foot of the person and is rotatably coupled to the front frame 110.

The leg rest unit 130 includes a footrest unit 131 for supporting a foot of a person and a connection portion 132 for connecting the footrest unit 131 to the front frame 110.

The footrest unit 131 is formed to have a predetermined area so that both feet of a person can be seated. In addition, one end of the connection portion 132 is coupled to the footrest unit 131, and the other end thereof is hinged to the front frame 110. Therefore, the leg rest unit 130 may be rotated by the connection portion 132 to be folded into the front frame 110.

In addition, the first module 100 further includes an auxiliary wheel 140.

The auxiliary wheel 140 is coupled to one side of the front frame 110 to assist the movement or driving of the electric wheelchair 10. In detail, a plurality of auxiliary wheels 140 may be provided and may be provided at lower ends of both sides of the second frame 122, respectively. The auxiliary wheel 140 may include a caster.

On the other hand, the second module 200 may include a rear frame 210, a backrest unit 220 which is coupled to one side of the rear frame 210, and a main wheel 230 which is coupled to the other side of the rear frame 210.

The rear frame 210 is disposed at the rear of the electric wheelchair 10 and supports parts for driving the electric wheelchair 10. The rear frame 210 may be formed as a closed curve in which the inside thereof is empty.

The backrest unit 220 may be disposed above the rear frame 210, and the main wheel 230 may be disposed below the rear frame 210.

According to an embodiment, the rear frame 210 may include an upper frame 211 supporting the backrest unit 220 and a lower frame 212 which is connected to the lower portion of the upper frame 211 and supports the main wheel 230.

The upper frame 211 and the lower frame 212 may be integrally formed. The upper frame 211 and the lower frame 212 may be connected to each other to form a single closed curve.

The upper frame 211 may be formed to be inclined backward, for example, be being formed in a “ [symbol] ” shape. The upper frame 211 may extend toward the front as being lowered downward.

In addition, the backrest unit 220 may be installed on an upper portion of the upper frame 211. The backrest unit 220 may be installed on an upper inner surface of the upper frame 211.

The lower frame 212 further extends downward from both lower sides of the upper frame 211. In detail, the lower frame 212 may extend toward both the rear and the lower side of the electric wheelchair 10 from both lower end portions of the upper frame 211.

Meanwhile, based on FIG. 3, the angle C formed by the upper frame 211 and the lower frame 212 may be designed to be larger than 90 degrees and smaller than 120. In other words, the angle C formed by the side surface of the upper frame 211 and the side surface of the lower frame 212 may be designed at an obtuse angle.

In addition, a slide protrusion (not illustrated) may be formed on the rear frame 210.

The slide protrusion is configured to be inserted into the slide groove 111a of the front frame 110 so that the front frame 110 can be coupled to the rear frame 210.

The slide protrusions may be formed to protrude from both inner surfaces of the rear frame 210, respectively. The slide protrusion may be formed in a straight line in the front and rear direction.

The slide protrusion may be provided at a portion where the upper frame 211 and the lower frame 212 are connected. Alternatively, the slide protrusion may be provided at a boundary area between the upper frame 211 and the lower frame 212.

Therefore, since the first frame 111 may be coupled to a portion corresponding to the middle height of the rear frame 210, the front frame 110 and the rear frame 210 may be stably coupled. The height of the seating unit 120 can be easily adjusted.

The backrest unit 220 includes a seat 221 and a seat cover 222 coupled to a rear surface of the seat 221.

The sheet 221 may be formed of soft and elastic material as a portion which is in contact with back part when a person is seated on the seating unit 120.

The seat cover 222 is coupled to the rear surface of the seat 221 as a portion supporting the seat 221. The seat cover 222 may be coupled to the inside of the rear frame 210.

In detail, the seat cover 222 may be coupled to an upper-end portion of the upper frame 211. For example, the seat cover 222 may be fastened by a fastening member to an inside surface of the upper frame 211.

The main wheel 230 is configured to allow the electric wheelchair 10 to drive substantially. The main wheel 230 is provided on both lower sides of the rear frame 210 and supports the load of the electric wheelchair 10. The main wheel 230 has a larger diameter than the auxiliary wheel 140.

Specifically, a pair of main wheels 230 are provided and may be installed on both lower sides of the lower frame 212, respectively. The main wheel 230 may include a motor 231, a rotation shaft, an inwheel, and a tire.

The motor 231 includes a stator, a rotor, a magnet, and the like, and generates a driving force to rotate the inwheel.

The rotation shaft is coupled to the inside of the rotor and may transfer the driving force generated by the motor 231 to the inwheel side.

The inwheel may be coupled to the rotation shaft to be rotated by receiving a driving force generated from the motor 231.

The tire is coupled to the outside of the inwheel and may elastically support the electric wheelchair 10 from the ground.

Here, the main wheel 230 may be referred to as a “driver” or “drive unit”. The driver may be robot.

In addition, the second module 200 may further include a control box 240 for controlling the motor 231.

The control box 240 may be installed below the rear frame 210.

In detail, the control box 240 is disposed at the lower end portion of the lower frame 212. The control box 240 has a substantially square shape and is provided inside the lower frame 212.

At this time, as illustrated in FIG. 3, the control box 240 may be disposed so that the side surface thereof is covered by the lower frame 212. In other words, the control box 240 is disposed to be inclined in correspondence to the inclination angle of the lower frame 212. Therefore, when the electric wheelchair 10 is viewed from the side, since the outer appearance of the control box 240 has a hidden structure, the electric wheelchair 10 has an advantage that the outer appearance is neat when driving.

The control box 240 may include a box case 241 forming an outer appearance and a plurality of electronic components 242 provided inside the box case 241.

In addition, the second module 200 may further include an armrest unit 250.

The armrest unit 250 is a portion that supports an arm or a hand when a person is seated.

The armrest unit 250 has a triangular shape, the armrest unit may be coupled to both sides of the rear frame 210, respectively. The armrest unit 250 may be provided to be rotatable on both sides of the rear frame 210, respectively.

In addition, the second module 200 may further include a controller 260.

The controller 260 is understood as a configuration that allows a user to operate the driving of the electric wheelchair 10. The controller 260 may include a display unit, a button unit, a joystick unit, and the like.

In addition, the second module 200 may further include a connection plate 270.

The connection plate 270 may be understood as a configuration for electrically connecting the first module 100 and the second module 200.

When the connection plate 270 and the first module 100 are connected, the power of the battery 123 of the first module 100 may be supplied to the motor 231 of the second module 200 and the electronic component 242.

In addition, the second module 200 may further include a basket mounting portion 280.

The basket mounting portion 280 is a portion for mounting a basket that can hold belongings and the like. The basket mounting portion 280 may be provided inside the rear frame 210.

Specifically, the basket mounting portion 280 may be formed to protrude on both inner sides of the lower frame 212, respectively. The basket mounting portion 280 may be elongated on the inner surface of the lower frame 212 in the front and rear direction.

The basket may be mounted by fastening the fastening member to the basket mounting portion 280. Alternatively, a portion of the basket may be mounted by being engaged with the basket mounting portion 280.

Hereinafter, the configuration of the armrest unit will be described in detail with reference to the drawings.

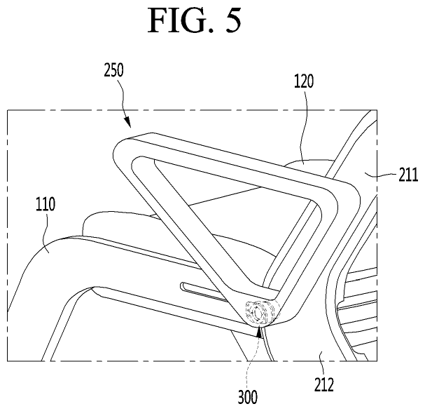

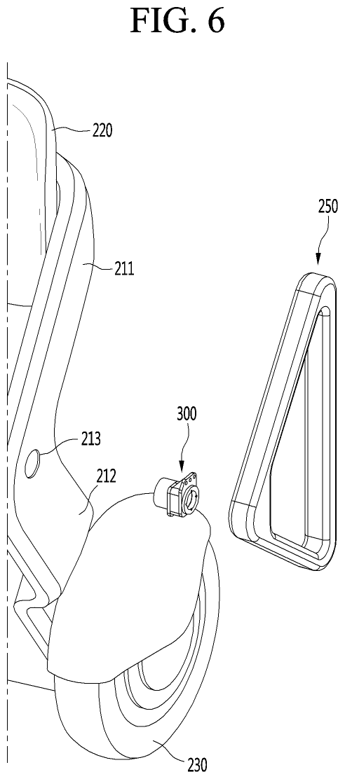

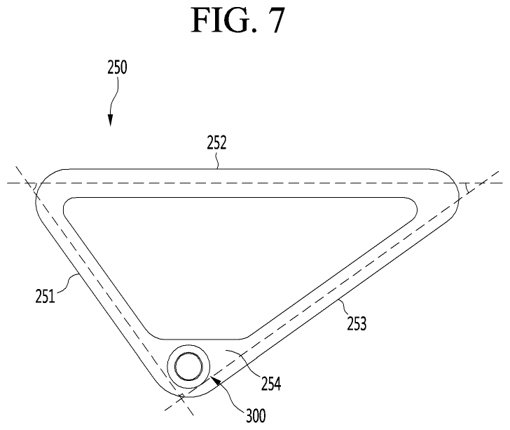

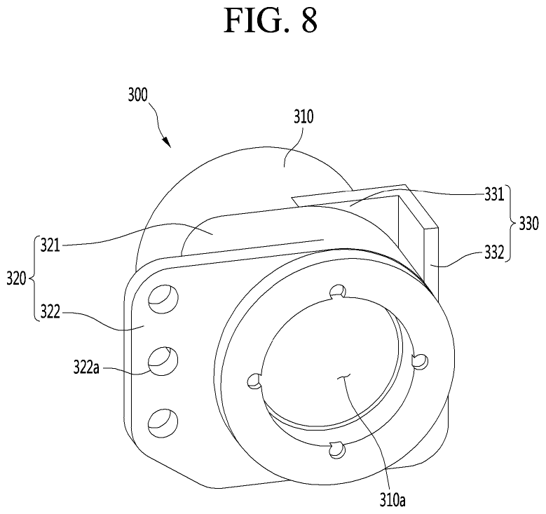

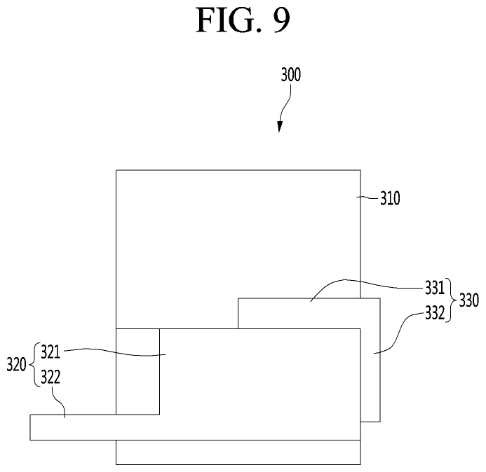

FIG. 5 is a view illustrating the inside of the armrest unit according to an embodiment of the present disclosure, FIG. 6 is an exploded perspective view illustrating the armrest unit according to the embodiment of the present disclosure, FIG. 7 is a side view illustrating the armrest unit according to an embodiment of the present disclosure, FIG. 8 is a perspective view illustrating a hinge assembly according to an embodiment of the present disclosure, and FIG. 9 is a plan view illustrating a hinge assembly according to an embodiment of the present disclosure.

Referring to FIGS. 5 to 9, the armrest unit 250 according to the present disclosure has a triangular shape and is provided to be capable of being rotated at an angle. In other words, the armrest unit 250 is hinged to both sides of the rear frame 210 and is provided rotatably from the first position to the second position.

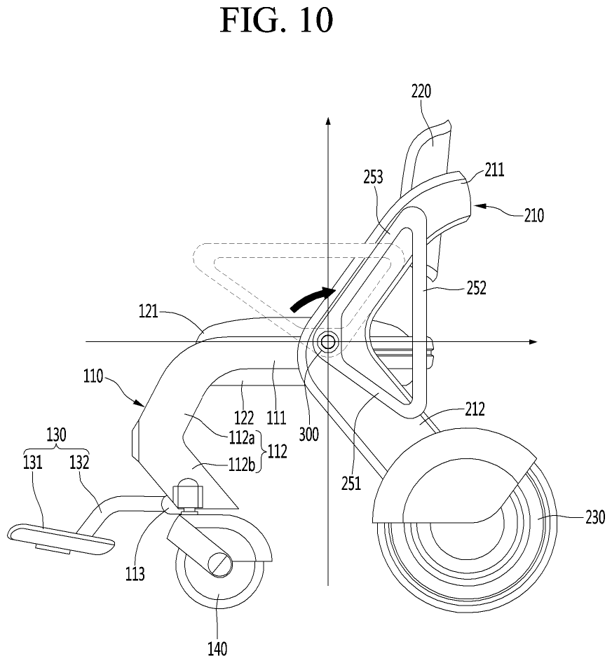

Here, the “first position” may mean that the armrest unit 250 is disposed in a direction horizontal to the ground based on FIG. 3. In addition, the “second position” may mean that the armrest unit 250 is rotated in a clockwise direction and is disposed in a direction perpendicular to the ground based on FIG. 10.

The first position may be defined as an initial position.

In other words, the armrest unit 250 may be rotated clockwise or counterclockwise, for example, may be rotated clockwise in the initial state of FIG. 3 and positioned in the state of FIG. 10. On the contrary, for example, the armrest unit 250 may be rotated counterclockwise in a state of FIG. 10 to return to the initial state of FIG. 3.

According to the present embodiment, the armrest unit 250 may be formed in a triangular shape with an empty inside. In detail, the armrest unit 250 may include a first portion 251 extending in the vertical direction, a second portion 252 extending forward from an upper-end portion of the first portion 251, and a third portion 253 extending forward from the lower end portion of the first portion 253.

At this time, an end portion of the second portion 252 and an end portion of the third portion 253 may be connected to form a triangular armrest unit. In other words, the armrest unit 250 may form a closed curve in which the inside is empty.

The first portion 251 may be disposed to overlap the side surface of the rear frame 210. In other words, in the first position, the first portion 251 may be disposed to overlap the side surface of the upper frame 211 of the rear frame 210.

The second portion 252 may be disposed in a direction parallel to the ground at the first position. In other words, the second portion 252 may be formed extending from the upper-end portion of the first portion 251 in a direction parallel to the ground.

The third portion 253 may be disposed to be inclined upwardly from the lower end portion of the first portion 251. In other words, the third portion 253 may extend from the lower end portion of the first portion 251 to be formed to the end portion of the second portion 252.

At this time, an angle D formed between the first portion 251 and the third portion 253 may be perpendicular to each other. In other words, the armrest unit 250 may have a right triangle shape.

In addition, the armrest unit 250 may further include a hinge coupling portion 254 through which the hinge assembly 300 to be described later passes.

The hinge coupling portion 254 is a portion in which the hinge assembly 300 to be described later is installed and is formed at any point inside the armrest unit 250.

In the present embodiment, the hinge coupling portion 254 may be provided at a point where the first portion 251 and the third portion 253 meet. In other words, the hinge coupling portion 254 may be formed at a vertex portion having the largest internal angle among the internal angle s of the armrest unit 250.

According to this configuration, since the hinge assembly 300 may be provided in a relatively large area of the inside of the armrest unit 250, there is an advantage that the armrest unit 250 can be easily rotated.

In other words, it may be advantageous in terms of rigidity that the hinge assembly 300 is formed at the vertex portion having the largest internal angle among the internal angles of the armrest unit 250, as compared to that the hinge assembly 300 is formed at the vertex portion having the smallest internal angle among the internal angles of the armrest unit 250.

The armrest unit 250 further includes a hinge assembly 300.

The hinge assembly 300 is a part that helps the armrest unit 250 to rotate at the predetermined angle in the rear frame 210.

The hinge assembly 300 may be fixed to the side surface of the rear frame 210 while being coupled to the armrest unit 250. The hinge assembly 300 may be fastened to the hinge fastening hole 213 formed on the side surface of the rear frame 210.

Specifically, the hinge assembly 300 includes a shaft portion 310 penetrating through the armrest unit 250 and a rotation portion 320 that is rotatably inserted into an outer circumferential surface of the shaft portion 310.

In addition, the hinge assembly 300 may further include a rotation limiting portion 330 formed to surround the outer circumference of the rotation portion 320 to limit the rotation angle of the rotation portion 320.

One side of the shaft portion 310 is fixed to the rear frame 210, the other side thereof is fixed to the armrest unit 250. The shaft portion 310 may be formed in a cylindrical shape of the hollow 310a.

The rotation portion 320 is rotatably coupled to the outer circumferential surface of the shaft portion 310.

In detail, the rotation portion 320 may be rotated by being fitted to an outer circumferential surface of the shaft portion 310. The rotation portion 320 may have an inner circumferential surface in contact with an outer circumferential surface of the shaft portion 310, and an outer portion thereof may be fixed to an inner surface of the armrest unit 250.

In other words, when the rotation portion 320 is rotated, the armrest unit 250 fixed to the rotation portion 320 may be rotated together.

In the present embodiment, the rotation portion 320 may include a rotation body 321 fitted to the outer circumferential surface of the shaft portion 310 and an engaging portion 322 extending from the outer surface of the rotation body 321.

The rotation body 321 has a hollow shape and the shaft portion 310 may be inserted therein. The rotation body 321 may be formed to have the same diameter as the shaft portion 310. In other words, when the rotation body 321 is fitted to the shaft portion 310, the outer side of the rotation body 321 and the outer side of the shaft portion 310 may be smoothly connected without a step.

The engaging portion 322 may extend outward from the outer circumferential surface of the rotation body 321 in the radial direction. For example, the engaging portion 322 may have a plate shape and an inner surface of the armrest unit 250 may be fixed to at least a portion of the engaging portion 322.

At this time, the engaging portion 322 may be formed with a fastening hole 322a for fixing with the inner surface of the armrest unit 250. Therefore, the armrest unit 250 may be fixed to the engaging portion 322 by the fastening of the fastening member, and thus may be rotated together with the rotation of the rotation body 321.

The rotation limiting portion 330 functions to prevent the rotation of the rotation portion 320 by being in contact with a portion of the rotation portion 320 when the rotation portion 320 is rotated. In other words, the rotation limiting portion 330 may physically prevent the rotation of the rotation portion 320.

The rotation limiting portion 330 may be provided on an outer circumferential surface of the shaft portion 310.

Specifically, the rotation limiting portion 330 may extend outward from the outer circumferential surface of the shaft portion 310. The rotation limiting portion 330 may extend from the outer circumferential surface of the shaft portion 310 to surround the outer circumference of the rotating portion 320.

At this time, the rotation limiting portion 330 is a protrusion portion 331 protruding outward from the outer circumferential surface of the shaft portion 310 in the radial direction, an interference portion 332 bent in a direction toward the rotating portion 320 from the end portion of the protrusion portion 331.

The protrusion portion 331 may extend in an opposite direction to a direction in which the engaging portion 322 extends from the outer circumferential surface of the shaft portion 310. In addition, the interference portion 332 may be bent at a right angle from an end portion of the protrusion portion 331.

Here, the interference portion 332 is formed to surround a portion of the circumference of the rotation body 321 and may extend to a point of contact with a portion of the engaging portion 322 when the rotation body 321 is rotated.

In other words, when the rotation body 321 is rotated so that the engaging portion 322 is rotated, a portion of the engaging portion 322 is in contact with the interference portion 332 so that the rotation of the engaging portion 322 is stopped. By the configuration of the present disclosure, it is possible to limit the rotation angle or amount of rotation of the rotation portion 320.

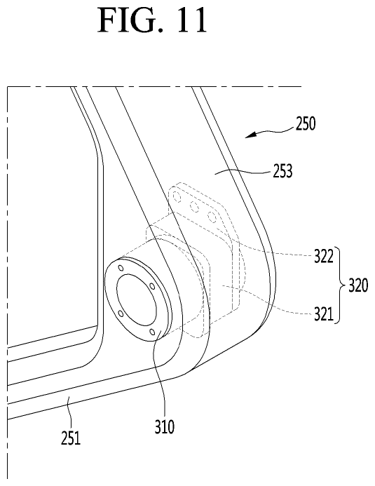

FIG. 10 is a side view illustrating a state where the armrest unit is rotated from the first position to the second position according to an embodiment of the present disclosure, and FIG. 11 is a transparent perspective view illustrating the hinge assembly in a state where the armrest unit is rotated to the second position according to an embodiment of the present disclosure.

Referring to FIGS. 10 and 11, as described above, the armrest unit 250 may be rotated clockwise from a first position, which is an initial position, to move to a second position.

At this time, the first portion 251 of the armrest unit 250 is disposed to overlap with the side surface of the upper frame 211 in the first position and is disposed to overlap with the side surface of the lower frame 212 in the second position.

In addition, the second portion 252 of the armrest unit 250 is disposed in the direction horizontal to the ground in the first position and is disposed in the direction perpendicular to the ground in the second position.

In addition, the third portion 253 of the armrest unit 250 is disposed below the second portion 252 in the first position and is disposed to overlap with the side surface of the upper frame 211 in the second position.

In other words, the first portion 251, the second portion 252, and the third portion 253 constituting the armrest unit 250 are rotated from the first position to the second position to be capable of opening the side of the seating unit 120. Therefore, the side boarding of the electric wheelchair 10 may be possible.

In addition, the first portion 251, the second portion 252, and the third portion 253 may be disposed to overlap the side surface of the rear frame 210.

In particular, the third portion 253 may face the same direction as the direction in which the upper frame 211 extends upward in the second position. Accordingly, there are advantages that the outer appearance of the electric wheelchair 10 is neat, and the volume thereof can be reduced when storing the wheelchair.

On the other hand, if the armrest unit 250 continues to rotate in the clockwise direction, the rotation portion 320 of the hinge assembly 300 interferes with one side of the rotation limiting portion 330 and thus the rotation thereof may be stopped.

In other words, while the engaging portion 322 of the rotation portion 320 is rotated in the circumferential direction, one surface of the engaging portion 322 may be in contact with one surface of the interference portion 332. Then, the engaging portion 322 is no longer rotated by the interference of the interference portion 332, the rotation of the armrest unit 250 may be stopped.

At this time, an elastic body for maintaining a state where the rotation of the armrest unit 250 is stopped may be provided to the hinge assembly 300.

In this embodiment, the rotation angle of the armrest unit 250 may be limited to 90 degrees. However, the present disclosure is not limited thereto, and the rotation amount of the armrest unit 250 may be variously designed.

In addition, in the present embodiment, the armrest unit 250 is described as having a triangular shape but is not limited thereto. The armrest unit having a square shape may be applied.

At this time, a hinge assembly is provided at an inner vertex portion of the square armrest unit, and the armrest unit may be rotated by the predetermined angle by the hinge assembly.

The electric wheelchair according to the embodiment of the present disclosure constituting the above configuration has the following effects.

First, since the armrest unit of the electric wheelchair is provided to be rotatable, ease of use is improved.

Specifically, when the armrest unit is rotated from the first position to the second position, a portion of the armrest unit is disposed to overlap with the side surface of the frame, and thus the armrest unit can open the side of the seating portion. In other words, when the side of the seating unit is opened, there is an advantage that the side of the wheelchair becomes easier.

Second, since the rotation angle of the armrest unit is limited by the hinge assembly, there is an advantage that excessive rotation of the armrest unit is prevented. In other words, since the rotation amount of the armrest unit can be properly adjusted, there is an advantage that can prevent product damage due to over-rotation and improve the stability.

Third, since the armrest unit can be rotated to be disposed to overlap the side surface of the frame, there is an advantage that the wheelchair storage is easy since the entire volume of the wheelchair can be reduced when the wheelchair is stored.

Fourth, since the armrest unit is hinged to the frame in a simple way, there is an advantage that the assembly of the armrest unit is easy and the product price is low.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric wheelchair comprising:
a seat configured to allow a person to be seated;
a frame configured to support the seat;
a driver configured to be coupled to the frame; and
an armrest configured to be hinged to the frame,
wherein the armrest includes:
a first portion which extends in a vertical direction and is disposed to overlap a side surface of the frame;
a second portion which extends forwardly from an upper-end portion of the first portion; and
a third portion which extends forwardly from a lower end portion of the first portion, and
wherein, when the armrest is rotated from the first position to the second position, at least any one of the first portion and the third portion is disposed to overlap the side surface of the frame.

2. The electric wheelchair of claim 1, wherein a triangular armrest is formed by connecting an end portion of the second portion and an end portion of the third portion to each other.

3. The electric wheelchair of claim 2, wherein the angle formed by the first portion and the third portion is a right angle.

4. The electric wheelchair of claim 1, wherein the frame includes:
an upper frame located above the seat; and
a lower frame located below the seat.

5. The electric wheelchair of claim 4, wherein the angle formed by the side surface of the upper frame and the side surface of the lower frame is an obtuse angle.

6. The electric wheelchair of claim 4, wherein the first portion is disposed to overlap the side surface of the upper frame at the first position.

7. The electric wheelchair of claim 6, wherein the first portion is disposed to overlap with the side surface of the lower frame at the second position.

8. The electric wheelchair of claim 7, wherein the third portion is disposed to overlap with the side surface of the upper frame at the second position.

9. The electric wheelchair of claim 1, wherein the second portion is disposed in a direction horizontal to the ground at the first position and is disposed in a direction perpendicular to the ground at the second position.

10. The electric wheelchair of claim 1, further comprises:
a hinge assembly configured to connect the armrest and the frame.

11. The electric wheelchair of claim 10, wherein the hinge assembly is installed so as to pass through the point where the first portion and the third portion of the armrest meet.

12. The electric wheelchair of claim 10, wherein the hinge assembly includes:
a shaft configured to pass through the armrest; and
a rotation portion configured to be provided so as to be fitted to the outer circumferential surface of the shaft and to be rotatable, and
wherein the rotation portion is fixed to an inner surface of the armrest.

13. The electric wheelchair of claim 12, wherein the hinge assembly further includes:
a rotation limiting portion which configured to be formed so as to surround the outer circumference of the rotation portion, the rotation limiting portion being configured to limit the rotation angle of the rotation portion.

14. The electric wheelchair of claim 13, wherein the rotation limiting portion includes:
an interference portion configured to extend outward from an outer circumferential surface of the shaft to be in contact with a portion of the rotation portion when the rotation portion rotates.

15. The electric wheelchair of claim 14, wherein the rotation portion includes:
a rotation body configured to be inserted into the outer circumferential surface of the shaft so as to rotate; and
an engaging portion configured to extend outward from an outer circumferential surface of the rotation body in a radial direction, and
wherein the engaging portion is interfered with the rotation by being in contact with the interference portion when the rotation body rotates.

16. An electric wheelchair comprising:
a seat;
a frame configured to support the seat;
a driver configured to be coupled to the frame; and
an armrest configured to be hinged to the frame,
wherein the armrest is formed in a triangular shape with an empty inside, and
wherein, when the armrest is rotated with respect to the frame by a predetermined angle, at least a portion of the armrest is disposed to overlap a side surface of the frame.

17. The electric wheelchair of claim 16, wherein the armrest includes:
a first portion which extends in a vertical direction and is disposed to overlap the side surface of the frame;
a second portion which extends forwardly from an upper-end portion of the first portion; and
a third portion which extends forwardly from a lower end portion of the first portion.

18. The electric wheelchair of claim 17, wherein, when the armrest is rotated with respect to the frame by a predetermined angle, at least any one of the first portion and the third portion is disposed to overlap the side surface of the frame.

19. The electric wheelchair of claim 17, wherein the angle formed by the first portion and the third portion is a right angle.

20. The electric wheelchair of claim 17, wherein the frame includes:
an upper frame located above the seat; and
a lower frame located below the seat,
wherein the first portion of the armrest is disposed to overlap the side surface of the upper frame at an initial position, and
wherein, when the first portion of the armrest is rotated by the predetermined angle from the initial position, the first portion of the armrest is disposed to overlap the side surface of the lower frame.
